(19) United States
(12) Patent Application Publication
(10) Pub. No.: US 2015/0336819 A1
(43) Pub. Date: Nov. 26, 2015

(54) ION ABSORPTION/DESORPTION DEVICE AND A METHOD THEREOF AS WELL AS A PH ADJUSTOR

(71) Applicant: KONINKLIJKE PHILIPS N.V., Eindhoven (NL)

(72) Inventors: Jianyu JIN, EINDHOVEN (NL); Guangwei WANG, EINDHOVEN (NL); Peixin HU, EINDHOVEN (NL)

(73) Assignee: Koninklijke Philips N.V., Eindhoven (NL)

(21) Appl. No.: 14/654,857

(22) PCT Filed: Dec. 19, 2013
(86) PCT No.: PCT/IB2013/061124

§ 371 Date: Jun. 23, 2015

(30) Foreign Application Priority Data
Dec. 24, 2012 (CN) PCT/CN2012/001724

(51) Int. Cl. C02F 1/469; B01J 20/28; B01D 15/26; B01J 20/24; C02F 1/28; C02F 1/461

(52) U.S. Cl. CPC C02F 1/4691; C02F 1/4696; C02F 1/285; C02F 1/286; C02F 1/46109; B01D 15/26; B01J 20/24; B01J 20/28047; C02F 2201/46; C02F 2001/46138

(57) ABSTRACT

The present invention provides an ion absorption/desorption device and a corresponding method. The ion absorption device may comprise: an electrode pair (12, 14), at least one electrode of the electrode pair (12, 14) being covered by ions-permeable gel (16a) with functional groups, the gel (16a) absorbing ions in a liquid (26a) when a voltage is applied on the electrode pair (12, 14). Covering the electrode with ions-permeable gel with functional groups may facilitate chelation of the cations and/or anions in the liquid with the functional groups in the gel, thereby, immobilizing these ions in the gel so as to improve absorption efficiency.

### FIELD OF THE INVENTION

The present invention relates to an ion absorption/desorption device and a method thereof as well as a pH adjustor, in particular, relates to performing absorption/desorption to ions in the liquid using gels.

### BACKGROUND OF THE INVENTION

Mineral ions, including cations such as sodium, calcium, iron, copper ions and anions such as chloride, bromide, sulphate and carbonate ions, are considered as major solutes dissolved in water. In people's daily life and work, unwanted ions in e.g. aqueous solution usually need to be removed. The skilled person in the art ever assumes to stuff inorganic oxide gel in the brine chamber to reconstruct the electrodialysis apparatus such as disclosed in U.S. Pat. No. 3,847,788. When gel contacts with concetrated brine solution, syneresis takes place therefore electrolyte is exuded as overflow from gel, which eliminates the brine stream thereby lowering storage, pumping and piping requirements. However, such device still suffers from shortcomings such as complex construction, scaling problems, simutanelous generation of unwanted brine solution during deionization, which brings trouble in domestic use.

### OBJECT AND SUMMARY OF THE INVENTION

In view of the above problems, an ion absorption device for improving ion absorption speed and absorption efficiency is in urgent need in the art.

Therefore, the object of the present invention lies in solving at least one of said problems.

According to a first aspect of the present invention, it provides an ion absorption device, the device may comprise: an electrode pair, at least one electrode of the electrode pair is covered by ions-permeable gel with functional groups, the gel absorbs ions in a liquid when a voltage is applied on the electrode pair. Covering the electrode by ions-permeable gel with functional groups facilitates chelation of the cations such as sodium, calcium, iron, copper ions and the anions such as chloride, bromide, sulphate and carbonate ions in the liquid with the functional groups in the gel, thereby immobilizing these ions in the gel so as to improve absorption efficiency. In addition, what is used in respective embodiments of the present invention is ions-permeable gel, such an ions-permeable gel is inflatable in the solution, which on the one hand absorbs water in the solution and on the other hand absorbs the unwanted ions in the solution firmly. Different from the inorganic oxide gel used in e.g. U.S. Pat. No. 3,847,788, the gel used here will not exude the electrolyte even when a high concentration of salts is absorbed, which inhibits the simultaneous generation of unwanted brine solution.

In one embodiment of the present invention, the gel used therein may comprise natural polymers or synthetic polymers.

In another embodiment of the present invention, wherein the natural polymers may comprise: agarose, methylcellulose and hyaluronan; the synthetic polymers may comprise: polyacrylamide, polyvinyl alcohol, acrylate polymers and copolymers.

In a further embodiment of the present invention, the ion absorption device may further comprise: conductive materials between at least one electrode of the electrode pair and the gel, the conductive materials include at least one of: titanium, platinum, gold, rhodium, ruthenium; Ti—Ru alloy, graphite, active carbon, porous carbon paper or cloth. The conductive materials between at least one electrode and the gel facilitate the gel to cover the electrode better so as to enhance the binding force between them.

According to a second aspect of the present invention, it provides a pH adjustor comprising said ion absorption device. One electrode of the electrode pair is covered by the gel, and the gel absorbs H⁺ or OH⁻ ions in a liquid when a voltage is applied on the electrode pair. Acidic water or alkaline water with different pH values can be generated based on user requirement by using the pH adjustor of the present invention.

According to a third aspect of the present invention, it provides an ion desorption device, which may comprise: an electrode pair, at least one electrode of the electrode pair is covered by ions-permeable gel with functional groups, the gel desorbs ions absorbed in the gel into a liquid when a reverse voltage is applied on the electrode pair. In the case of applying the reverse voltage, the repulsive force generated by the ions chelated together with the functional groups under the electric force is greater than the binding force with the functional groups, therefore, those ions bonded together with the functional groups will leave the gel successively and get into the solution. Thus, it is benefit for recycle use of the gel on the one hand, and acquisition of solution with desired ion content on the other hand.

In one embodiment of the present invention, the gel used therein may comprise natural polymers or synthetic polymers.

In another embodiment of the present invention, wherein the natural polymers may comprise: agarose, methylcellulose and hyaluronan; the synthetic polymers may comprise: polyacrylamide, polyvinyl alcohol, acrylate polymers and copolymers.

In a further embodiment of the present invention, the ion desorption device may further comprise: conductive materials between at least one electrode of the electrode pair and the gel, the conductive materials include at least one of: titanium, platinum, gold, rhodium, ruthenium; Ti—Ru alloy, graphite, active carbon, porous carbon paper or cloth. The conductive materials between at least one electrode and the gel facilitates the gel to cover the electrode better so as to enhance the binding force between them.

According to the fourth aspect of the present invention, it provides an ion absorption method, which may comprising the steps of: applying a voltage on an electrode pair, wherein at least one electrode of the electrode pair is covered by ions-permeable gel with functional groups, such that the gel absorbs ions in the liquid.

In one embodiment of the present invention, the gel used therein may comprise natural polymers or synthetic polymers.

In a further embodiment of the present invention, it may further comprise: conductive materials between at least one electrode of the electrode pair and the gel, the conductive materials include at least one of: titanium, platinum, gold, rhodium, ruthenium; Ti—Ru alloy, graphite, active carbon, porous carbon paper or cloth.

According to the fifth aspect of the present invention, it provides an ion desorption method, comprising: applying a reverse voltage on an electrode pair, wherein at least one electrode of the electrode pair is covered by ions-permeable gel with functional groups, so as to desorb ions absorbed in the gel into a liquid.

In one embodiment of the present invention, the gel used therein may comprise natural polymers or synthetic polymers.

In a further embodiment of the present invention, it may further comprise: conductive materials between at least one electrode of the electrode pair and the gel, the conductive materials may include at least one of: titanium, platinum, gold, rhodium, ruthenium; Ti—Ru alloy, graphite, active carbon, porous carbon paper or cloth.

### BRIEF DESCRIPTION OF THE DRAWINGS

The above and other features of the present invention will become more obvious through detailed explanation of embodiments shown in the drawings, in which the same or similar reference signs represent the same or similar components, wherein:

FIG. 1A schematically shows an ion absorption device according to one aspect of the present invention.

FIG. 1B schematically shows an ion absorption device in an alternative embodiment of the present invention.

FIG. 1C schematically shows an ion absorption device in another alternative embodiment of the present invention.

FIG. 2 schematically shows that conductive materials are arranged between the electrode and the gel in an ion absorption device in an alternative embodiment of the present invention.

FIG. 3A schematically shows a pH adjustor according to another aspect of the present invention.

FIG. 3B schematically shows a pH adjustor in an alternative embodiment of the present invention.

FIG. 4A schematically shows an ion desorption device according to one aspect of the present invention.

FIG. 4B schematically shows an ion desorption device in an alternative embodiment of the present invention.

FIG. 4C schematically shows an ion desorption device in another alternative embodiment of the present invention.

### DETAILED DESCRIPTION OF EMBODIMENTS

The present invention will be described hereinafter in detail with reference to the drawings of the present invention and the schematic embodiments thereof.

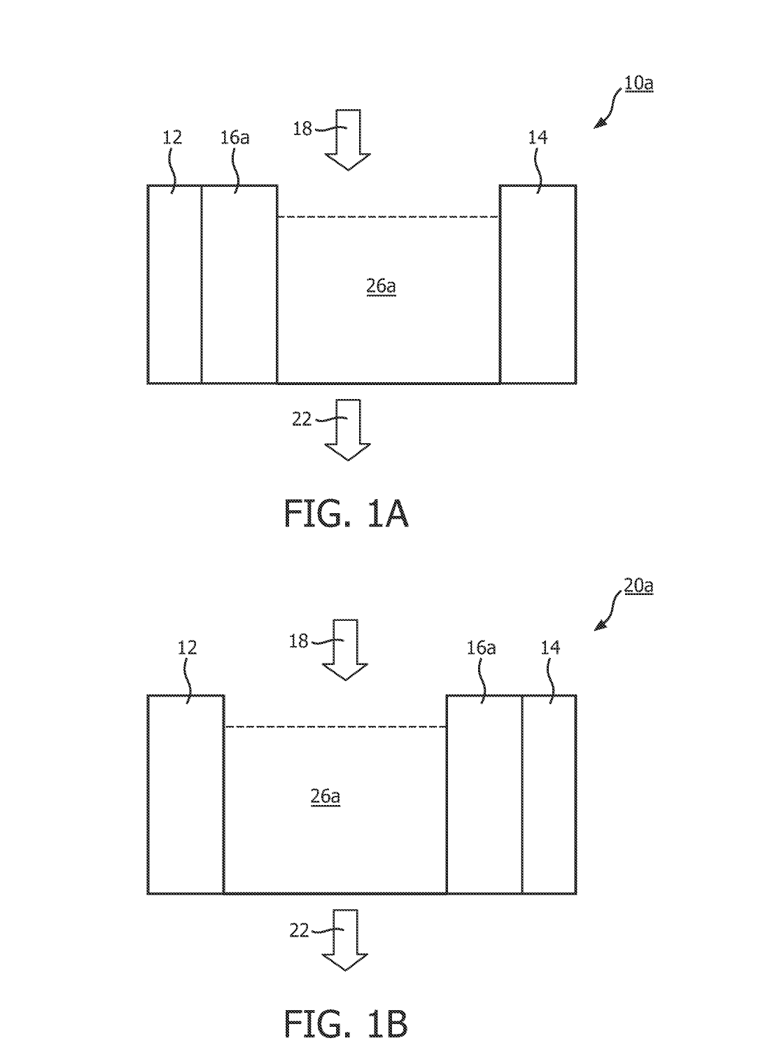

Firstly, referring to FIGS. 1A-1C, FIG. 1A schematically shows an ion absorption device 10a according to one aspect of the present invention. The ion absorption device 10a may comprise an electrode pair 12, 14, at least one electrode of the electrode pair 12, 14 is covered by ions-permeable gel 16a with functional groups, the gel 16a absorbs ions in a liquid 26a when a voltage is applied on the electrode pair 12, 14. In respective embodiments of the present invention, various materials can be used as the material of the electrode pair 12, 14 of the present invention, for example, metals such as Ti, Pt, Au, Rh and Ru, or alloys as Ti—Ru, or carbon based materials such as graphite and active carbon.

In FIG. 1A, it is schematically shown that a first electrode 12 of the electrode pair 12, 14 is covered by an ions-permeable gel 16a with functional groups. In a modified embodiment of the present invention, e.g., FIG. 1B, it is shown that a second electrode 14 of the electrode pair 12, 14 is covered by an ions-permeable gel 16a with functional groups. In another modified embodiment of the present invention, e.g., FIG. 1C, it is shown that both the first electrode 12 and the second electrode 14 of the electrode pair 12, 14 are covered by an ions-permeable gel 16a with functional groups. Such modifications exist because different ions in the liquid 26a need to be absorbed. This will be further mentioned below.

The ions-permeable gel 16a or 16b (which will be mentioned later) with functional groups used in respective embodiments of the present invention is substantially a cross-linked system exhibiting no flow when in the steady-state. These gels are mostly liquid, yet they behave like solids due to a three-dimensional cross-linked network within the liquid.

Such ions-permeable gels 16a with functional groups can be used for ion absorption for the following reasons: 1) Over 90% of the total weight of gel is water, which has high permeability, and ions can get into the gel by free diffusion or under electric force. 2) The three-dimensional cross-linked network limits the mobility of the absorbed ions, preventing them from leaking out. 3) The active groups contained in gel such as hydroxyl groups, amino groups and carboxyl groups, which depend on the gel ingredients, can bind with ions by hydrogen bonding interaction or electrostatic interaction. Therefore, ions absorbed by gel can be further stabilized.

The gel 16a used in respective embodiments of the present invention may comprise natural polymers or synthetic polymers. The natural polymers comprise: agarose, methylcellulose and hyaluronan; the synthetic polymers comprise: polyacrylamide, polyvinyl alcohol, acrylate polymers and copolymers.

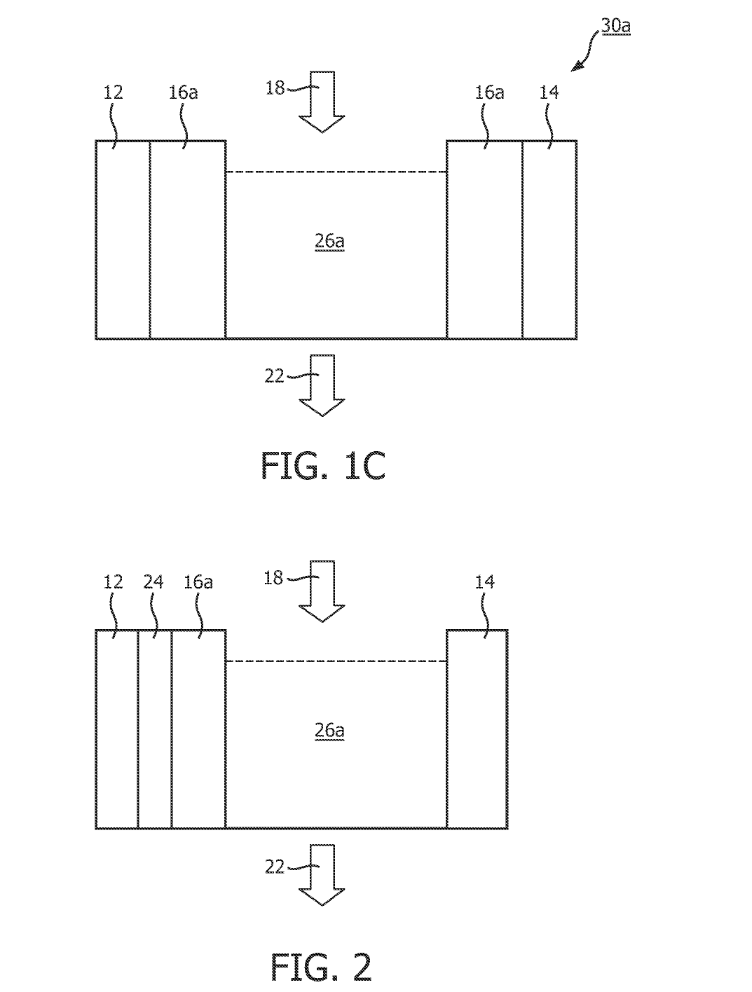

Preferably, the ion absorption device comprises conductive materials 24 between at least one electrode of the electrode pair 12, 14 and the gel 16a, the conductive materials 24 include at least one of: titanium, platinum, gold, rhodium, ruthenium; Ti—Ru alloy, graphite, active carbon, porous carbon paper or cloth, as schematically shown in FIG. 2.

In order to understand the ion absorption device of the present invention better, schematic description will be made below through several embodiments.

### Embodiment 1

The first electrode 12 of the electrode pair 12, 14 in FIG. 1A serves as a cathode, the second electrode 14 serves as an anode, the liquid 26a used therein can be e.g. water containing Ca²⁺. The surface of the first electrode 12 is covered by agarose gel. The chemical formula of the agarose gel is:

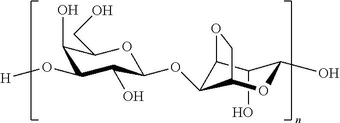

Namely, hydroxyl groups are contained in the chemical formula of the agarose gel. In the case of applying a voltage on the first electrode 12 and the second electrode 14, the Ca²⁺ in the water moves towards the first electrode 12 which serves as the cathode during the absorption, and gets into the gel. Since the hydroxyl groups in the agarose gel chelated the Ca²⁺, the Ca²⁺ is immobilized in the gel. Meanwhile, the water is deoxidized at the cathode surface, i.e., the following reaction occurs: 2H₂O+2e=H₂+2OH⁻, thereby, H₂ and OH⁻ are generated on the cathode surface. Part of the Ca²⁺ that get into the agarose gel chelated with the hydroxyl groups, while the other part of the Ca²⁺ continuously move towards the cathode in the agarose gel, the OH⁻ ion as an ion with opposite polarity from Ca²⁺ generates closely bond Ca(OH)₂ by maintaining neutral electricity, i.e., the OH⁻ ion reacting with Ca²⁺, so as to stabilize the Ca ions in the gel further. The Ca²⁺ ions in the water are removed through said absorption of Ca²⁺ ions.

The skilled person in the art should understand that a corresponding ions-permeable gel 16a with functional groups can be used for a different ion absorption. For example, the methylcellulose, the methyl methacrylate, the methacrylic acid, the polyacrylamide and the methyl allyl sulfonate gel, acrylate polymers, copolymers have carboxyl functional groups, the hyaluronan and the polyvinyl alcohol have hydroxyl functional groups, and the polyurethane has amino functional groups, etc. The skilled person in the art should understand that the various natural polymer gels or synthetic polymer gels listed here are only demonstrative, which does not mean that the gels used in the respective embodiments of the present invention are limited to these. The hydrogel for absorbing heavy metal ions generally comprises various chelated functional groups, such as carboxyl (—COOH), amido (—NH₂), hydroxyl (—OH), sulfonic group (—SO₃) etc., so, if the hydrogel in general does not comprise functional groups for chelating heavy metal, chemical reaction should occur to itself to introduce such functional groups, or to introduce other substances to form copolymers so as to obtain such functional groups. This means that the skilled person in the art can make modification to the gel based on actual needs such that the gel covering the electrode can have one functional group such as amido, two functional groups such as amido and carboxyl, or three functional groups at the same time such as amido, carboxyl, and hydroxyl, or more other functional groups. This is not difficult for the skilled person in the art to realize, which will not be elaborated here.

The above embodiment 1 only schematically explains the process of absorbing the Ca²⁺ ions in water. During the process of carrying out the present invention, it may also need to absorb other ions e.g. cations such as sodium ions, iron ions, copper ions, or e.g. anions such as chloride ions, bromine ions, sulfate ions and carbonate ions. For example, in the case of absorbing the cations such as sodium ions, iron ions, copper ions in water, the surface of the first electrode 12 as the cathode should be covered by gel 16a. For example, in the case of absorbing the anions such as chloride ions, bromine ions, sulfate ions and carbonate ions in water, the surface of the second electrode 14 as the anode should be covered by gel 16a, i.e., using the ion absorption device as shown in FIG. 1B. For example, in the case of simultaneously absorbing the cations such as sodium ions, iron ions, copper ions and the anions such as chloride ions, bromine ions, sulfate ions and carbonate ions in water, both the surface of the first electrode 12 as the cathode and the surface of the second electrode 14 as the anode should be covered by gel 16a, i.e., using the ion absorption device as shown in FIG. 1C. Of course, the gels covering the first electrode 12 and the second electrode 14 may differ from each other based on needs. This is not difficult for the skilled person in the art to understand.

Alternatively, the ion absorption device as shown in FIGS. 1A-1C and FIG. 2 may comprise an input 18 for inputting the liquid 26a, e.g. water containing Ca²⁺ ions etc. Alternatively, the ion absorption device as shown in FIGS. 1A-1C may further comprise an output 22 for outputting water after removal of the Ca²⁺ ions etc. For example, in the case that the water needs to be softened, the liquid 26a input from the input 18 is hard water containing Ca²⁺ ions, Mg²⁺ ions etc. After the liquid 26a is processed by the ion absorption device 10a, 20a or 30a, it is soft water output from the output 22 with the Ca²⁺ ions, Mg²⁺ ions, etc. removed. In the case of for example removing heavy metal ions from the liquid 26a, what are inputted and outputted from the input 18 and the output 22 should be respectively water containing heavy metal ions and the corresponding deionized water. This is not difficult to understand.

### Embodiment 2

In this schematic embodiment, the fabricating process of agarose gel will be introduced schematically.

Generally, at the temperature of 90° C., agarose of 2 g can be dissolved in deionized water of 100 ml. When the agarose is completely dissolved, the agarose solution is poured into an electrode module containing electrodes, e.g. the electrode module containing the first electrode 12 and/or the electrode module containing the second electrode 14. Preferably, conductive material 24, such as carbon cloth, is applied between the electrode module and the agarose solution. The purpose of applying the carbon cloth lies in enhancing the bonding force between the agarose gel formed by the agarose solution and the electrode due to the concavo-convex shape of the surface of the carbon cloth. After cooling at room temperature for two hours, the agarose gel is formed on the surface of the first electrode 12 or the surface of the second electrode 14 or the surfaces of both. Subsequently, the electrode covered by the gel 16a is used for ion absorption.

The embodiment 2 takes the agarose gel formed on the surface of the electrode as example. According to the teaching of the present invention, the skilled person in the art needs to select different gel materials for absorbing different ions in the liquid 26a. After the corresponding gel materials are selected, it is not difficult to fabricate the corresponding gel on the corresponding electrode surface. It will not be elaborated in the present invention.

### Embodiment 3

In order to explain the absorption speed and absorption efficiency of the present invention, the agarose gel fabricated in embodiment 2 will be used to cover the surfaces of the first electrode 12 and the second electrode 14 to perform the following experiment. The liquid 26a used in embodiment 3 is water containing Ca²⁺, CO₃²⁻, K⁺ and Cl⁻ ions. The liquid 26a is input from the input 18 to a reaction chamber constituted by the first electrode 12 and the second electrode 14, and the agarose gel covering the first electrode 12 and the second electrode 14. DC voltage of 30V is applied on the first electrode 12 and the second electrode 14, standard titration is used to detect the content of ions in the liquid 26a. The detected data is shown in Table 1 below.

TABLE 1
Absorption of different cations and anions under a voltage of 30 V.

| | Time | | | | | | |
|---|---|---|---|---|---|---|---|
| | 0 min | 5 min | 10 min | 20 min | 30 min | 40 min | |
| | | | | | | | 60 min |
| Ca²⁺ | 4.8 | 3.8 | 3.2 | 2.3 | 1.8 | 1.1 | 0.54 |
| (mM) | | | | | | | |
| CO₃²⁻ | 5.0 | 4.6 | 3.6 | 3.4 | 3.0 | 2.5 | 1.2 |
| (mM) | | | | | | | |
| | | | | | | | 80 min |
| K⁺ (mM) | 5 | 3.75 | 2.67 | 0.89 | 0.71 | 0.53 | 0.36 |
| Cl⁻ (mM) | 5 | 3.98 | 3.28 | 2.01 | 1.09 | 0.7 | 0.55 |

It is shown in Table 1 that the initial concentrations of the Ca²⁺, CO₃²⁻, K⁺ and Cl⁻ ions are respectively 4.8 mM, 5.0 mM, 5 mM, 5 mM. After the voltage is applied for 10 minutes, the detected concentrations of the Ca²⁺, CO₃²⁻, K⁺ and Cl⁻ ions are respectively 3.2 mM, 3.6 mM, 2.67 mM, 3.28 mM. After the voltage is applied for 30 minutes, the detected concentrations of the Ca²⁺, CO₃²⁻, K⁺ and Cl⁻ ions are respectively 1.8 mM, 3.0 mM, 0.71 mM, 1.09 mM. After the voltage is applied for 60 minutes, the detected concentrations of the Ca²⁺, CO₃²⁻, K⁺ and Cl⁻ ions are respectively 0.54 mM, 1.2 mM, 0.36 mM, 0.55 mM. It can be seen from the above experimental data that the longer time the voltage is applied, the lower the concentrations of the residual ions in the liquid 26a are, which means that more and more ions are absorbed on the agarose gel. Taking the Ca²⁺ for example, in the case of applying a DC voltage of 30V for 60 minutes, only 0.54 mM Ca²⁺ remains, which means that the Ca²⁺ substantially chelated with the hydroxyl groups through chelation, and as part of Ca²⁺ continuously move towards the cathode in the agarose gel, OH⁻ ions generated at the cathode surface as counter ions of Ca²⁺ generate closely bonded Ca(OH)₂ by maintaining neutral electricity, i.e., the OH⁻ ions reacting with Ca²⁺, so as to further stabilize the Ca²⁺ ions in the water. These Ca(OH)₂ and the chelated Ca²⁺ are all located on surface or inside of the agarose gel, or in a general term, on the agarose gel.

The above embodiments 1-3 of the present invention only take the agarose gel as example. It is not difficult for the skilled person in the art to understand that natural polymers or synthetic polymers may be used in the process of carrying out the present invention. The natural polymers may comprise: agarose, methylcellulose and hyaluronan etc. The synthetic polymers may comprise: polyacrylamide, polyvinyl alcohol, acrylate polymers and copolymers etc. The gels listed above are all ions-permeable gels with functional groups. In the case of applying a voltage, the ions e.g. cations such as sodium ions, iron ions, copper ions, or e.g. anions such as chloride ions, bromine ions, sulfate ions and carbonate ions in the liquid can be chelated together with the functional groups in the gel by covering the surface of the electrode with such gels. Thereby, these ions are quickly immobilized in the gel, and the absorption efficiency is improved.

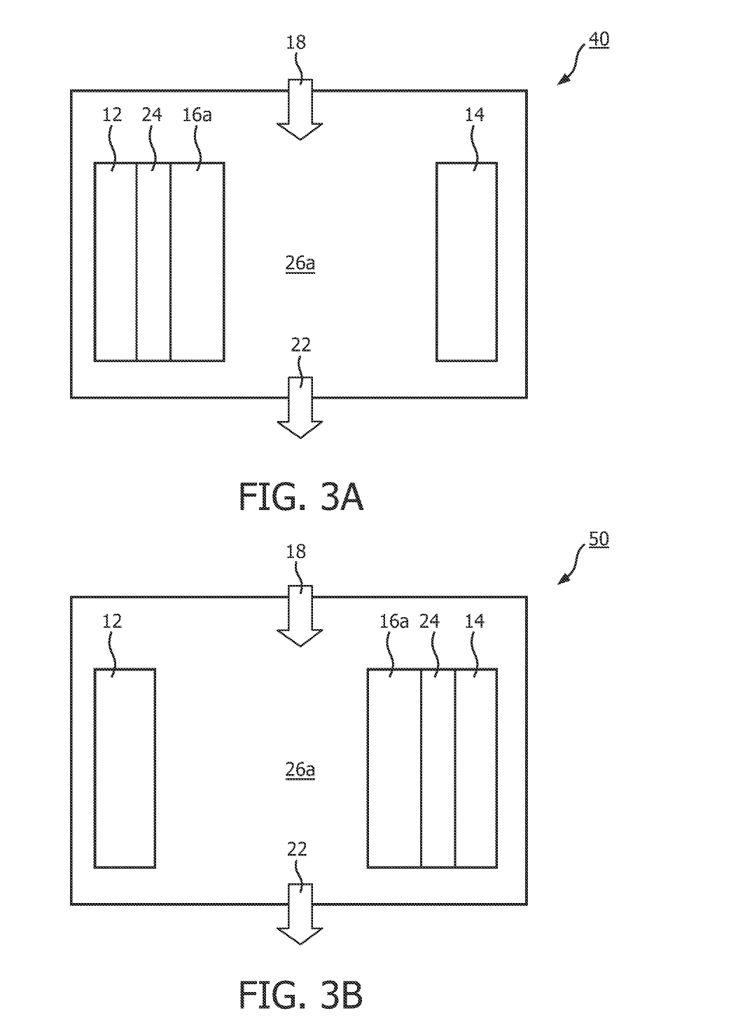

Subsequently, FIGS. 3A-3B of the present invention will be described. FIG. 3A schematically shows a pH adjustor 40. FIG. 3B schematically shows a pH adjustor 50 in an alternative embodiment of the present invention. One electrode of the electrode pair 12, 14 is covered by a gel 16a, the gel 16a absorbs H⁺ or OH⁻ ions in a liquid 26a when a voltage is applied on the electrode pair 12, 14. In people's daily life and work, acidic water or alkaline water with different pH values might be required. The second electrode 14 as shown in FIG. 3B is covered by e.g. hyaluronic acid gel, which gel has hydroxyl functional groups. Alternatively, conductive material 24 e.g. carbon cloth is used between gel 16a e.g. hyaluronic acid gel and the second electrode 14. In the case of inputting liquid 26a e.g. tap water at the input 18, the following reaction occurs on the first electrode 12 as the cathode: 4H₂O+4e=2H₂+4OH⁻. Namely, generating hydrogen and OH⁻ ions near the first electrode 12, the OH⁻ ions get into the liquid 26a directly. The following reaction occurs on the anode surface e.g. the surface of the second electrode 14: 2H₂O−4e=O₂+4H⁺. The generated H⁺ will be chelated by the hyaluronic acid gel, i.e., being immobilized in the gel. In order to maintain neutral electricity of the gel, part of the anions in the liquid 26a will be absorbed in the gel. Since the H⁺ ions generated near the second electrode 14 are substantially captured in the gel, while the amount of the OH⁻ ions in the tap water is far greater than that of the H⁺ ions, alkaline water is thus obtained, thereby pH adjustment of the tap water is realized. The inventor also finds that alkaline water with different pH values can be obtained by controlling the magnitude and duration of the voltage applied.

Of course, by means of the pH adjustor as shown in FIG. 3A of the present invention, acidic water can also be obtained. Here large amount of H⁺ ions are generated near the second electrode 14, these H⁺ ions will get into the liquid 26a directly. The OH⁻ ions generated near the first electrode 12 will be chelated by the methylcellulose gel with carboxyl functional groups. Here the amount of the H⁺ ions in the tap water is far greater than that of the OH⁻ ions, acidic water is thus obtained, thereby pH adjustment of the tap water is realized. Similarly, alkaline water with different pH values can be obtained by controlling the magnitude and duration of the voltage applied.

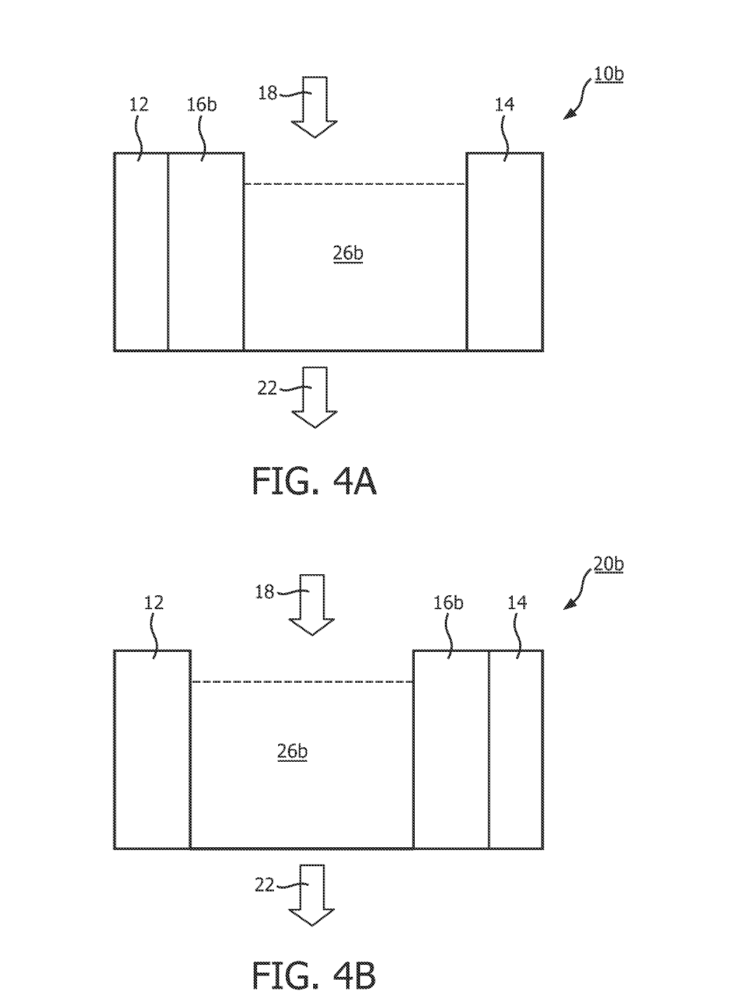

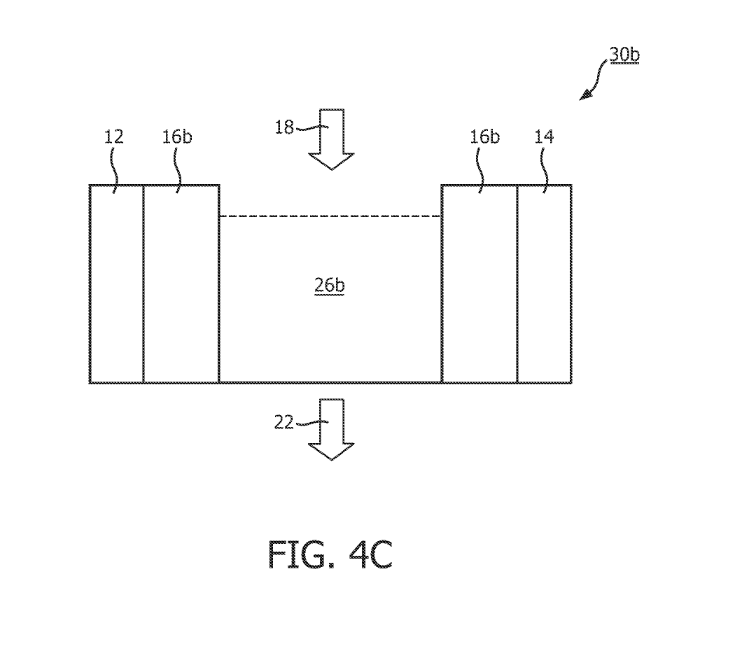

FIGS. 4A-4C of the present invention will be described below. FIG. 4A schematically shows an ion desorption device according to one aspect of the present invention. FIG. 4B schematically shows an ion desorption device in an alternative embodiment of the present invention. FIG. 4C schematically shows an ion desorption device in another alternative embodiment of the present invention. All of the ion desorption devices 10b, 20b, 30b as schematically shown in FIGS. 4A-4C comprise an electrode pair 12, 14, at least one electrode of the electrode pair 12, 14 is covered by an ions-permeable gel 16b with functional groups, the ions absorbed in the gel 16b is desorbed into a liquid 26b when a reverse voltage is applied on the electrode pair 12, 14. The difference between FIGS. 4A-4C only lies in that the gel 16b is applied at different positions. In FIG. 4A, only the first electrode 12 is covered by the gel 16b, in FIG. 4B, only the second electrode 14 is covered by the gel 16b, in FIG. 4C, both the first electrode 12 and the second electrode 14 are covered by the gel 16b.

It should be pointed out that the ion desorption process concerned in FIGS. 4A-4C is equivalent to a reverse operation of the ion absorption process as shown in FIGS. 1A-1C. For example, in the event that the gel used in FIGS. 1A-1C has been nearly saturated, i.e., when the gel approaches absorption balance, the ions captured in the gel need to be released, thus it is benefit for recycle use of the gel on the one hand, and acquisition of solution with desired ion content on the other hand.

For example, a reverse voltage is applied on the electrode pair 12, 14, wherein at least one electrode of the electrode pair 12, 14 is covered by an ions-permeable gel 16b with functional groups in order to desorb the ions absorbed in the gel 16b into the liquid 26b. For example, driven by electric force, the absorbed cations are released from the gel 16b and get into the liquid 26b. For example, in order to enable the absorbed cations such as sodium ions, iron ions, copper ions to be desorbed from the gel, a positive voltage can be applied to the electrode covered by the gel, in this way, since the polarity of the electrode and that of the cations absorbed in the gel are same, a repulsive effect is generated, thereby the cations absorbed in the gel are desorbed into the liquid 26b. The similar operation can be performed to the absorbed anions, i.e., applying a negative voltage to the electrode covered by the gel, so as to desorb the anions absorbed in the gel into the liquid 26b. This is easy for the skilled person in the art to understand.

For example, in the situation as shown in FIG. 4C, both the first electrode 12 and the second electrode 14 are covered by agarose gel. Wherein the first electrode 12 is covered by agarose gel with calcium ions absorbed therein, while the second electrode 14 is covered by agarose gel with chloride ions absorbed therein. In the case of applying a reverse voltage in the electrode pair 12, 14, the calcium ions and the chloride ions absorbed in the agarose gel are respectively released from the corresponding gels, and get into the liquid 26b. Meanwhile, near the first electrode 12 as the anode, the water is oxidized to generate hydrogen ions, the hydrogen ions neutralize the hydroxyl ions in the gel. Similarly, near the second electrode 14 as the cathode, the water is deoxidized to generate hydroxyl ions, the hydroxyl ions neutralize the hydrogen ions in the gel.

The above is only a schematic explanation of FIG. 4C, as for the situations of FIG. 4A and FIG. 4B, the skilled person in the art can also realize them easily according to the teaching of the present invention, which will not be elaborated there.

Similarly, the gel 16b used in the ion desorption device in the respective embodiments of the present invention may comprise natural polymers or synthetic polymers, wherein the natural polymers may comprise: agarose, methylcellulose and hyaluronan; the synthetic polymers may comprise: polyacrylamide, polyvinyl alcohol, acrylate polymers and copolymers.

Alternatively, the ion desorption device in the respective embodiments of the present invention may comprise conductive materials 24 between at least one electrode of the electrode pair 12, 14 and the gel 16b, the conductive materials 24 include at least one of: titanium, platinum, gold, rhodium, ruthenium; Ti—Ru alloy, graphite, active carbon, porous carbon paper or cloth.

Corresponding to the ion absorption device introduced above, the present invention may further provide an ion absorption method. The method may comprise the steps of: applying a voltage on an electrode pair 12, 14, wherein at least one electrode of the electrode pair 12, 14 is covered by ions-permeable gel 16a with functional groups, such that the gel 16a absorbs ions in the liquid 26a.

Corresponding to the ion desorption device introduced above, the present invention may further provide an ion desorption method. The method may comprise the steps of: applying a reverse voltage on an electrode pair 12, 14, wherein at least one electrode of the electrode pair 12, 14 is covered by ions-permeable gel 16b with functional groups, so as to desorb ions absorbed in the gel 16b into a liquid 26b.

Similarly, in the various ion absorption/desorption methods of the present invention, the gel used therein may comprise natural polymers or synthetic polymers, wherein the natural polymers may comprise: agarose, methylcellulose and hyaluronan; the synthetic polymers may comprise: polyacrylamide, polyvinyl alcohol, acrylate polymers and copolymers.

Alternatively, in the various ion absorption/desorption methods of the present invention, it may comprise conductive materials 24 between at least one electrode of the electrode pair 12, 14 and the gel 16a, the conductive materials 24 include at least one of: titanium, platinum, gold, rhodium, ruthenium; Ti—Ru alloy, graphite, active carbon, porous carbon paper or cloth.

Although the present invention has been described with reference to the currently considered embodiments, it should be understood that the present invention is not limited to the disclosed embodiments. On the contrary, the present invention aims to cover various modifications and equivalent arrangements comprised within the spirit and scope of the claims as attached. The scope of the following claims complies with the broadest explanation so as to comprise all such modifications and equivalent structures and functions.

In the claims, the word “comprising” does not exclude other elements or steps, and the indefinite article “a” or “an” does not exclude a plurality. A single unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

1. (canceled)

2. (canceled)

3. (canceled)

4. (canceled)

5. A pH adjustor, comprising;
an ion absorption device, wherein the ion absorption device comprising:
an electrode pair, at least one electrode of the electrode pair being covered by ions-permeable gel with functional groups, the gel absorbing ions in a liquid when a voltage is applied on the electrode pair;
the gel absorbing H⁺ or OH⁻ ions in a liquid when a voltage is applied on the electrode pair.

6. An ion desorption device, comprising:
an electrode pair, at least one electrode of the electrode pair being covered by ions-permeable gel with functional groups, the gel desorbing ions absorbed in the gel into a liquid when a reverse voltage is applied on the electrode pair.

7. The ion desorption device according to claim 6, wherein the gel comprises natural polymers or synthetic polymers.

8. The ion desorption device according to claim 7, wherein the natural polymers comprise: agarose, methylcellulose and hyaluronan; the synthetic polymers comprise: polyacrylamide, polyvinyl alcohol, acrylate polymers and copolymers.

9. The ion desorption device according to claim 6, further comprising:
conductive materials between at least one electrode of the electrode pair and the gel, the conductive materials include at least one of: titanium, platinum, gold, rhodium, ruthenium; Ti—Ru alloy, graphite, active carbon, porous carbon paper or cloth.

10. An pH adjustment method, comprising the steps of:
applying a voltage on an electrode pair, wherein at least one electrode of the electrode pair is covered by ions-permeable gel with functional groups, such that the gel absorbs ions in the liquid.

11. The pH adjustment method according to claim 10, wherein the gel comprises natural polymers or synthetic polymers.

12. The pH adjustment method according to claim 10, wherein conductive materials are used between at least one electrode of the electrode pair and the gel, and the conductive materials include at least one of: titanium, platinum, gold, rhodium, ruthenium; Ti—Ru alloy, graphite, active carbon, porous carbon paper or cloth.

13. An ion desorption method, comprising:
applying a reverse voltage on an electrode pair, wherein at least one electrode of the electrode pair is covered by ions-permeable gel with functional groups, so as to desorb ions absorbed in the gel into a liquid.

14. The ion desorption method according to claim 13, wherein the gel comprises natural polymers or synthetic polymers.

15. The ion desorption method according to claim 13, wherein conductive materials are used between at least one electrode of the electrode pair and the gel, the conductive materials include at least one of: titanium, platinum, gold, rhodium, ruthenium; Ti—Ru alloy, graphite, active carbon, porous carbon paper or cloth.

16. The pH adjuster according to claim 5, wherein the gel comprises natural polymers or synthetic polymers.

17. The pH adjustor according to claim 6, wherein the natural polymers comprise: agarose, methylcellulose and hyaluronan; the synthetic polymers comprise: polyacrylamide, polyvinyl alcohol, acrylate polymers and copolymers.

18. The pH adjustor according to claim 5, further comprising:
conductive materials between at least one electrode of the electrode pair and the gel, the conductive materials include at least one of: titanium, platinum, gold, rhodium, ruthenium; Ti—Ru alloy, graphite, active carbon, porous carbon paper or cloth.
